(19) United States
(12) Patent Application Publication
(10) Pub. No.: US 2017/0031841 A1
(43) Pub. Date: Feb. 2, 2017

(54) Peripheral Device Connection to Multiple Peripheral Hosts

(71) Applicant: Broadcom Corporation, Irvine, CA (US)

(72) Inventors: Sushil Philip Verghese, Aliso Viejo, CA (US); Srikrishna Raju Kalidindi, San Jose, CA (US)

(21) Appl. No.: 14/857,355

(22) Filed: Sep. 17, 2015

Related U.S. Application Data
(60) Provisional application No. 62/197,210, filed on Jul. 27, 2015.

(51) Int. Cl. G06F 13/10; G06F 13/42; G06F 13/40; G06F 13/20

(52) U.S. Cl. CPC G06F 13/102; G06F 13/20; G06F 13/4282; G06F 13/4004

(57) ABSTRACT

A communication system connects multiple host systems to a specific target device. As one example, the communication system may implement multiple peripheral component interface express (PCIe) bus links to the host systems that share a common downstream bus link to a specific target device. A multi-host bridge between the host systems and the specific target device may remap function requests from the host systems to unique function numbers, and may also perform flow control and other actions in support of communication between the multiple hosts and the specific target device.

### PRIORITY CLAIM

This application claims priority to U.S. Provisional application number 62/197,210, filed Jul. 27, 2015, which is incorporated herein by reference in its entirety.

### TECHNICAL FIELD

This disclosure relates to device busses and communication protocols. This disclosure also relates to connecting a specific device to multiple hosts for a given bus type.

### BACKGROUND

Rapid advances in electronics and communication technologies, driven by immense customer demand, have resulted in the widespread adoption of electronic devices of every kind. In many cases, the devices connect to and communicate with other devices over a bus adhering to a particular electrical, physical, and protocol specification. As one example, a network interface card may communication with a server host processor over a Peripheral Component Interface express (PCIe) bus. Improvements in connecting devices to hosts will further enhance the communication capabilities of the devices.

### BRIEF DESCRIPTION OF THE DRAWINGS

FIG. 1 shows a communication architecture for connecting multiple host systems to a specific target device.

FIG. 2 also shows a communication architecture for connecting multiple host systems to a specific target device.

FIG. 3 shows an example of downstream communication circuitry.

FIG. 4 shows an example of upstream communication circuitry.

FIG. 5 shows an example of logic for downstream communication from multiple host systems to a specific target device.

FIG. 6 shows an example of logic for upstream communication from a specific target device to multiple host systems.

### DETAILED DESCRIPTION

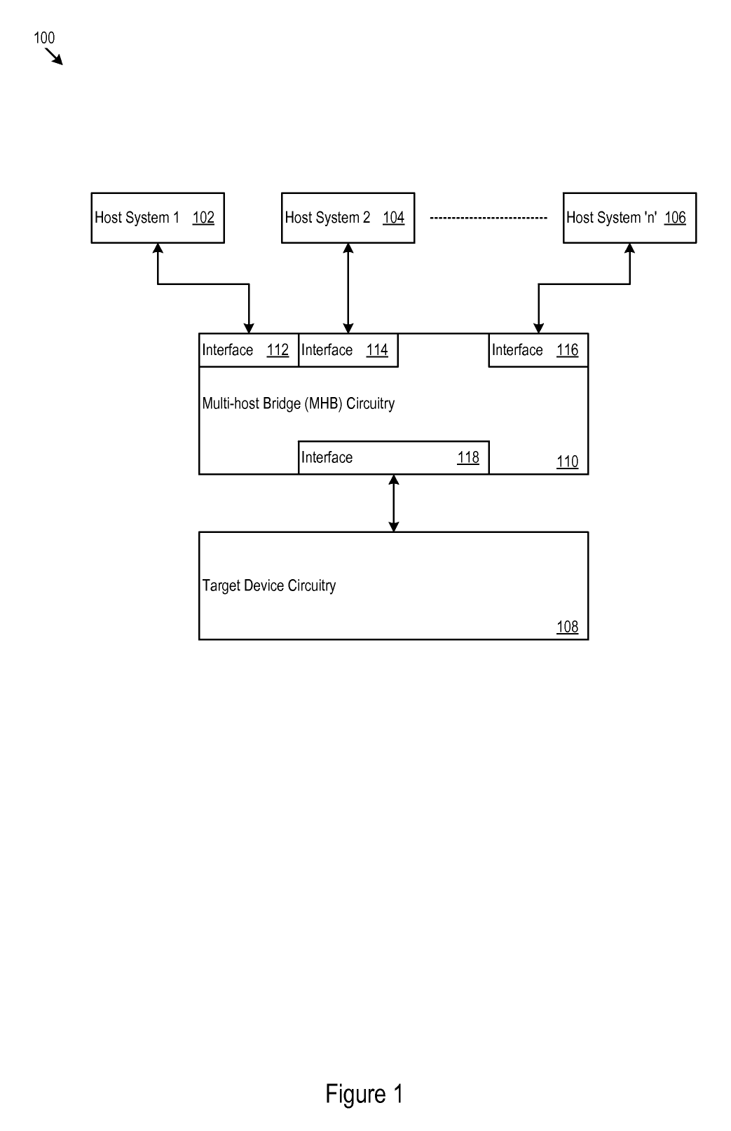

FIG. 1 shows a communication architecture 100 for connecting multiple host systems to specific target device circuitry. There may be any number of host systems, three of which are labeled in FIG. 1 as host systems 102, 104, and 106. The target device includes target device circuitry 108 that implements the desired functionality of the target device. In one implementation described in more detail below, the communication architecture 100 is a PCIe bus architecture.

The communication architecture 100 connects multiple host systems to a specific (e.g., single) target device. The target device circuitry 108 may implement a network interface card (NIC), serial AT attachment (SATA) device, solid state disk (SSD) or any other device. The communication architecture 100 may implement multiple peripheral component interface express (PCIe) bus links to the host systems that share a common downstream bus link to a specific target device. A multi-host bridge (MHB) 110 between the host systems and the specific target device remaps function requests from the host systems to unique function numbers, and also performs flow control and other actions in support of communication between the multiple hosts and the specific target device.

Expressed another way, the communication architecture 100 allows a specific target device to connect to multiple host systems through multiple independent communication interfaces, e.g., the PCIe interfaces 112, 114, and 116. The target device circuitry 108 communicates to the host systems through a communication interface as well, e.g., the PCIe interface 118. Thus, the target device need not adhere to the typical connection mechanism by which the target device has a one-to-one mapping with a host device. Furthermore, the communication architecture provides the one (device) to many (hosts) communication capability without requiring a multi-root aware switch and without requiring the complexity of multi-root i/o virtualization (MRIOV). In the communication architecture, the host systems and the target device may not even be aware that they are sharing the target device or communicating with different hosts, and they may thereby operate according to established PCIe protocols as though they alone own the link between the host system and the target device.

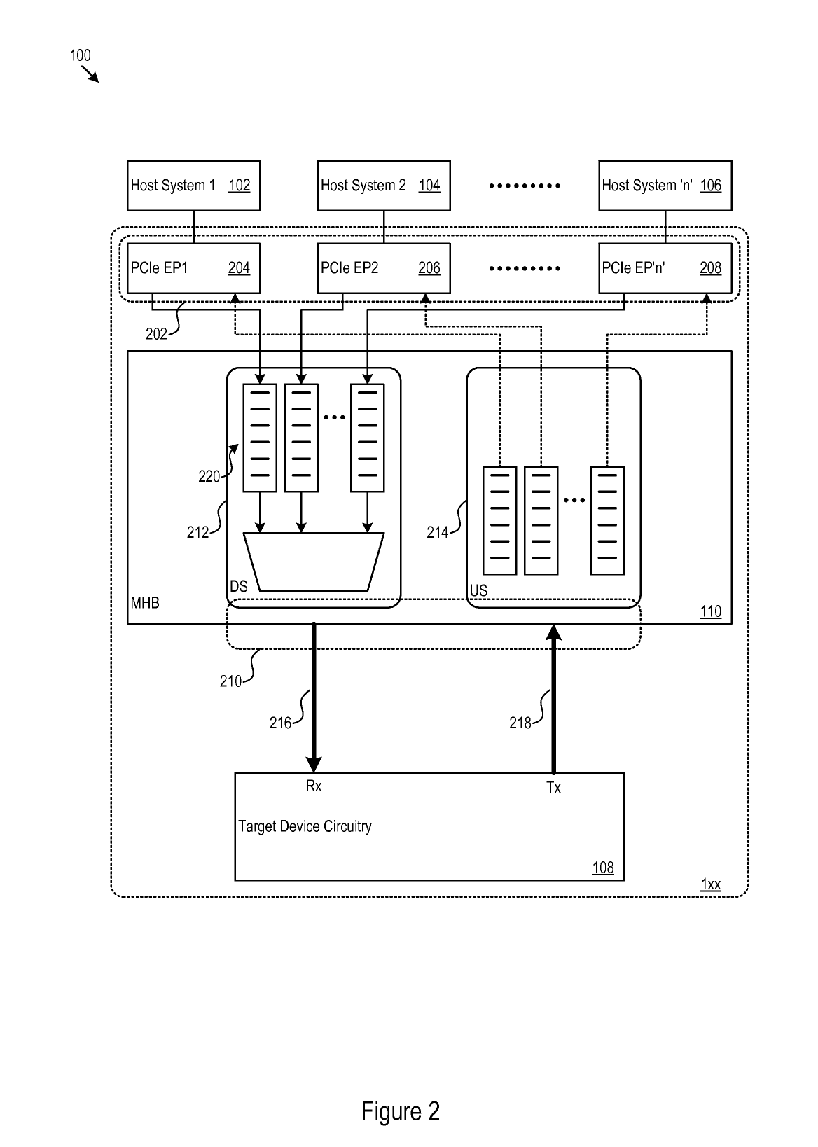

FIG. 2 shows another view of the communication architecture 100. An upstream communication interface 202 includes multiple host bus interfaces for a specific bus type, e.g., PCIe. Three of the bus interfaces are labeled 204, 206, and 208, and each bus interface may provide an independent root interface port for communication with any given endpoint (EP), e.g., for each different host system. A downstream communication interface 210 is also present. The downstream communication interface 210 provides a device bus interface for the target device circuitry 108, and is configured to provide a bidirectional downstream connection from the host bus interfaces to the target device circuitry.

The multi-host bridge circuitry (MHB) 110 connects the upstream communication interface 202 to the downstream communication interface 210. The MHB 110 serves as a bridge that allows multiple PCIe root ports to interface with a single device. The MHB 110 implements the bridging functionality behind PCIe endpoints in the interface logic to the device and to the host systems.

Note that the target device circuitry 108 is not aware that it is connected to multiple root ports, e.g., to the multiple bus interfaces 204, 206, 208. The MHB 110 operates to ensure that the target device circuitry 108 sees the requests from the different root ports as requests from independent PCIe functions. The MHB 110 translates the function requests from each root port to unique function number supported by the target device circuitry 108, so that the target device circuitry 108 sees the access from/to each root port as an access from/to a unique PCIe function.

The MHB 110 also includes arbitration circuitry configured to arbitrate among the multiple upstream root ports that are accessing the downstream port connected to the target device circuitry 108. In this regard, the MHB 110 includes buffers to absorb function requests delayed at one root port, while a different root port is transmitting or receiving. In addition, the MHB 110 includes bandwidth credit circuitry that releases credits to each upstream port and also performs credit management to the downstream port.

The MHB 110 implements downstream communication circuitry (DCC) 212 between the upstream communication interface 202 and the downstream communication interface 210. The MHB 110 also implements upstream communication circuitry (UCC) 214 between the upstream communication interface 202 and the downstream communication interface 210.

The DCC 212 handles transaction layer packets (TLPs) in the downstream (Rx) direction 216. The UCC 214 handles TLPs in the upstream (Tx) direction 218. The DCC 212 includes per-port buffering 220 for each upstream root port to handle packets in the Rx direction. This DCC 212 maps the Requester ID (RID) from each port to a unique function number for the downstream root port connected to the target device circuitry 108.

The UCC 214 implements separate interfaces for each of the upstream root ports. The UCC 214 also maintains per-port credit interfaces with the target device circuitry 108. The target circuitry 108 may perform credit checks, using credit check circuitry 428, for each upstream root port based on the function number in the request it is transmitting. The UCC 214 maps the RID in the request to the assigned function number of the upstream root port. Both the UCC 214 and the DCC 212 maintain ordering for TLP types within a root port, but need not maintain ordering between TLPs for different ports.

Expressed another way, the DCC 212 receives a first host request for a specific function number on the first host bus interface, and receives a second host request for the specific function number on the second host bus interface. Among other functions, the DCC 212 obtains a remapped host request by mapping the second host request to a different function number assigned to the second host system for the specific function number. The DCC 212 also sends the first host request to the target device circuitry 108, and also sends the remapped host request to the target device circuitry 108.

The UCC 214 receives a device function request transmitted by the target device circuitry 108 on the downstream communication interface 210. The UCC 214 maps the device function request to a selected host bus interface and function number for that host bus interface.

In the PCIe implementation example, the function mappings performed by the MHB 110 may represent allocations of functions across a PCIe function range supported by the target device circuitry 108. For instance, the MHB 110 may include a mapping of function numbers supported by the target device circuitry 108 (e.g., function numbers 0, 1, 2, 3, 4, 5, 6, 7, and 8) to the first host bus interface and the second host bus interface. The mapping may specify a first sub-range (e.g., functions 0, 1, 2, and 3) of the target device function numbers mapped to a particular host bus interface and a selected function range assigned to that first host bus interface (e.g., functions 0, 1, 2, and 3). The mapping may also specify a second sub-range of the target device function numbers (e.g., functions 4, 5, 6, and 7) mapped to a different host bus interface and also the selected function range (functions 0, 1, 2, and 3). That is, the first and second sub-ranges replicate functionality provided by the selected function range. The functions have unique numbers at the target device circuitry 108, and map to the same function numbers for the host systems.

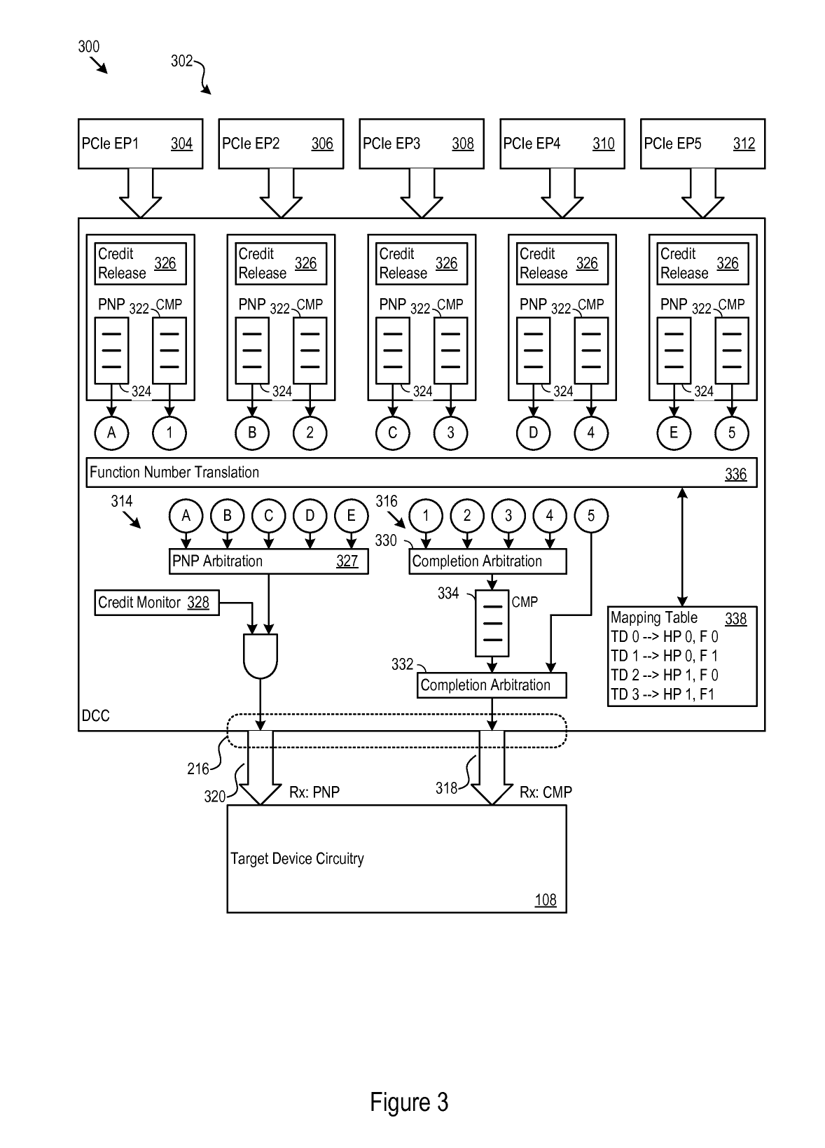

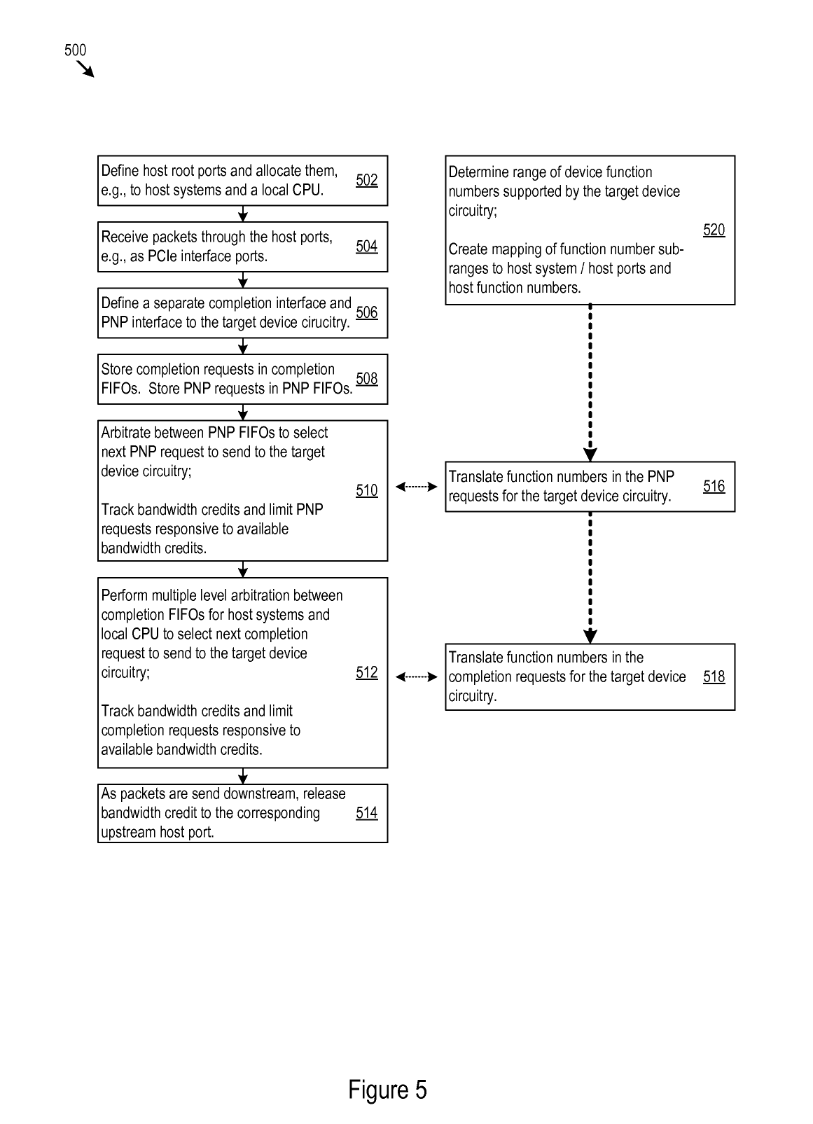

FIG. 3 shows an example DCC implementation 300, which is discussed below with reference to FIG. 5 which shows logic 500 for downstream communication. In this example, the DCC implementation 300 includes five root ports labeled 304, 306, 308, 310, and 312. The root ports 304-312 may be defined or allocated for any specific purpose or host processing system, including a root port allocated specifically to a local host CPU (502).

The DCC 212 services the root ports 304-312 that send packets to the downstream communication interface 210 and the target device circuitry 108. The DCC 212 effectively presents multiple PCIe controller user Rx interface ports that the host devices connect to and use to send packets to the target device (504). Each root port 304-312 interfaces with a PCIe IF controller through the user interface. Arbitration circuitry 314 and 316 arbitrates among the root ports 304-312 to select packets to send downstream.

The downstream direction 216 flows through an interface that is also the PCIe IF Rx user interface. In the implementation shown in FIG. 3, a completion interface 318 is provided as a separate interface from the PNP interface 320 (506). The completion interface 318 handles PCIe completion request packets, while the PNP interface 320 handles PCIe posted, non-posted, and other types of packets (PNP packets). The DCC 212 receives packets at a root port 304-312, and completion request packets are held in completion FIFOs 322 and PNP packets are held in the PNP FIFOs 324 (510).

The DCC 212 may accumulate received packet data to the datapath width prior to writing the packet data to the FIFOs 322 and 324. Corresponding to each root port 304-312, there may be PNP and CPL buffering 324 &322 to absorb the latency involved in the sending the packets downstream when other root ports have access to the target device. The FIFOs may also serve as clock domain crossing FIFOs when the upstream ports and downstream port of the MHB 110 are not clocked at the same clock frequency. The DCC 212 writes packets into the FIFOs 322 and 324 at the upstream root port clock frequency, while the DCC 212 reads packets from the FIFOs 322 and 324 at the frequency of the downstream root port and at the same data path width as the downstream root port.

As shown in FIG. 3 and noted above, each root port includes a PNP FIFO 324 and a completion FIFO 322. The MHB 110 implements a separate interface with the target device circuitry 108 for PNP requests, the PNP interface 320, and completion requests, the completion interface 318. The MHB 110 includes PNP decision circuitry 314 for deciding from which PNP FIFO 324 to retrieve a PNP request for communication over the PNP interface 320. The PNP decision circuitry 314 includes PNP arbitration circuitry 327 and credit monitoring circuitry 328. The PNP arbitration circuitry 327 may implement a round-robin selection mechanism among the PNP FIFOs 324, or any other selection mechanism. The credit monitoring circuitry 328 limits downstream PNP bandwidth according to the bandwidth credits that are available for PNP requests (510).

The MHB 110 also includes completion decision circuitry 316. The completion decision circuitry includes two levels of arbitration implemented with first stage arbitration circuitry 330 and second stage arbitration circuitry 332, and the completion arbitration FIFO 334 connecting the completion arbitration circuitry 330 and 332.

The completion decision circuitry 316 also implements a difference in behavior between the root ports for host systems and a root port assigned to a local CPU. The completion requests received at each root port for a host system are stored in the completion FIFOs 322, which may be relatively shallow. The first stage arbitration circuitry 330 may implement a weighted round-robin arbitration (e.g., weighted according to root port bandwidth), and the selected completion requests are stored in the relatively deeper completion arbitration FIFO 334. The FIFO 334 may be relatively deeper than FIFOs 322 because the FIFO 334 may handle traffic from multiple ones of the root ports. FIFO 334 may be sized in proportion to the increased traffic associated with multiple root ports 304-312 when compared to a single one of the root ports 304-312.

The completion arbitration FIFO 334 may provide rate matching, given that the bandwidth of the root ports 304-312 exceeds the bandwidth of the downstream communication interface 210. Further, in some implementations, the root port allocated to the local CPU may include a completion FIFO 322 that is deeper than the completion FIFOs for other host ports. In some cases, the bandwidth from the root ports, e.g., burst bandwidth, may exceed the bandwidth of the arbitration circuitry 332. For example, the combined bandwidth of the root ports may be 32 Generation Three (Gen3) lanes and the arbitration circuitry 332 may be setup to handle 24 Gen3 lanes, where the individual Gen3 lanes may handle 8 giga-transfers per second. Thus, FIFOs 322 may be sized according to the bandwidth of the individual root ports 304-312 served to ensure that the individual root ports may operate at peak bandwidths without loses occurring as a result of traffic from other root ports. In some cases, the endpoints may not necessarily have the same individual bandwidths. For example, root ports EP1 304-310 may individually have 4 Gen3 lanes for a total of 16 Gen3 lanes, while EP5 312 may have 16 Gen3 lanes. In the example, the FIFO 322 associated with EP5 312 would be larger, e.g., 4 times larger, than those of the other root ports 304-310. In some implementations, EP5 may not necessarily be associated with an external port. Instead EP5 may be an internal port used for data routing management for the other external ports. For example, EP5 may include a PCIe to Advanced extensible interface (AXI) bridge, version C (PAXC).

In the completion decision circuitry 316, the second stage arbitration circuitry 332 arbitrates (e.g., in weighted round-robin (WRR) manner) between completion requests from the local CPU completion FIFO, and the completion arbitration FIFO 334 (512). In some cases, the arbitration may take into account different bandwidth capabilities for the root ports. For example, if one root port, e.g., EP1 304, supports 8 Gen3 lanes and other port, e.g., EP2 306, supports 2 Gen3 lanes, the arbitration circuitry may be setup to pass traffic from the root ports in proportion to the bandwidth of the root ports. Thus, in the example, when the arbitration circuitry 332 is operating at capacity, traffic from EP1 304 may be passed 4 times more often than traffic from EP2. In some implementations, this proportional traffic passing may be achieved using WRR arbitration. However, other arbitration schemes that pass traffic in proportion to bandwidth may be used. In some cases, multiple arbitration stages may be used. For example, in the example with external root ports and one internal root port, arbitration for the external root ports (e.g., root ports 304-310) may be performed in a first stage (e.g., at arbitration circuitry 330), and arbitration of the internal root port (e.g., 312) against the external root ports (e.g., 304-310 after combination at 330) may be performed at a second stage (e.g., second stage arbitration circuitry 332). Thus, the second stage arbitration circuitry may allow for control of internal data versus external data.

As packets are sent downstream to the target device circuitry 108, credit for that transaction type is released to the corresponding upstream host port (514). The credit release circuitry 326 manages credit release for different traffic types: posted, non-posted, and completions, e.g., writes, reads, and completions, respectively. Posted-type traffic may include writes requests from the target device circuitry. Non-posted-type traffic may include reads from the target device circuitry. Completions may include traffic sent from the target device circuitry is response to reads sent from the host devices.

The credit release circuitry 326 may manage credit release separately for the individual ones of the root ports 304-312. As credits are released from the host devices connected to the root ports, the credit release circuitry 326 may hold the received credits. The credit release circuitry 326 may then re-release the credits in accord with the bandwidth availability of the DCC. Thus, the advertisement of credits to the target device can be prevented from exceeding the bandwidth availability of the individual host devices, and also may account for the bandwidth constraints and capacity DCC as the system arbitrates among the multiple hosts. In some implementations, credits may not necessarily be released for all traffic types. For example, in some systems, the links to the root devices may advertise infinite credits for completion type traffic (e.g., traffic sent in response to a read request). In such cases, credits need not necessarily be released for completion type traffic because infinite credits are available. The host device or target device that has traffic to send may hold that traffic until credits are available to support the traffic's corresponding traffic type.

The credit monitoring circuitry 328 performs credit management for each upstream host port. Since the target device is interfacing to multiple upstream host ports, the credit monitoring circuitry 328 allows traffic to be sent to the target device only if the target device has released sufficient credit to handle the traffic. The credit monitoring circuitry is also performed at the downstream communication interface 210 prior to a request being made to that port.

The MHB 110 also includes function number translation circuitry 336 and a routing table 338. The function number translation circuitry 336 translates the function number in the requests to a new function number so that the target device circuitry 108 sees the remapped request as having a unique function number. The function number translation circuitry 336 may perform translations for virtual functions and physical function numbers. The function numbers may be represented in the PCIe requester ID (RID) in the packets transmitted and received by the host systems and the target device. As such, remapping the function numbers may manifest itself as a change in the RID of the packets (516, 518).

In the example shown in FIG. 3, the MB 110 has determined a range of device function numbers supported by the target device circuitry: 0-3, e.g., by interrogating the target device circuitry 108. The MHB 110 has stored in the mapping table 338 a mapping of the device function numbers to a first host bus interface and a second host bus interface. The mapping includes a first sub-range of the device function numbers, 0-1, mapped to the first host bus interface and a selected function range, 0-1, and a second sub-range of the device function numbers, 2-3, mapped to: the second host bus interface and also the selected function range, 0-1. The first and second sub-ranges replicate functionality identified by the selected function range 0-1 (520).

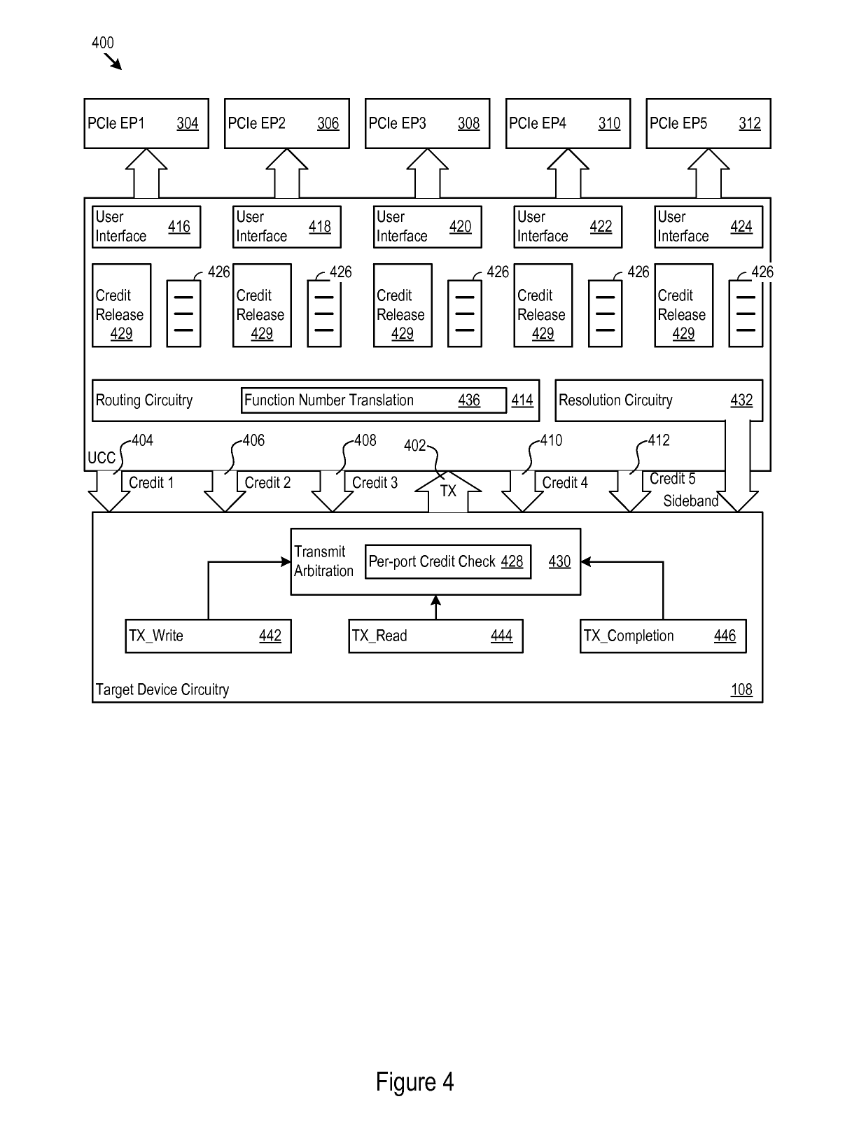

FIG. 4 shows an example UCC implementation 400. The UCC 214 services the target device circuitry 108 in its attempts to send packets to the upstream host systems. The UCC 214 implements a transmit interface 402 (e.g., a PCIe Controller User Tx Interface) for the target device circuitry 108 to transmit packets upstream through the communication interfaces 416, 418, 420, 422, and 424. The communication interfaces 416, 418, 420, 422, and 424 connect with the root ports EP1-EP5, 304-312, and interface with a device at a PCIe controller IF. The communication interfaces may include internal data buses that may have bit-widths set to sustain data transfers for the host devices connected to the interface. For example, the data buses on the communication interfaces may support multiple Gen3 lanes. The UCC 214 further defines credit interfaces to the target device circuitry 108, e.g., the credit interfaces 404, 406, 408, 410, and 412 for corresponding root ports 304-312.

The routing circuitry 414 in the UCC 214 routes the function requests from the target device circuitry 108 to the corresponding upstream root port. The routing circuitry 414 may perform the routing responsive to the function number in the request packet, with remapping performed from the target device function number to a particular host port and function number defined in the routing table 338. The routing circuitry 414 may follow a multiple stage request pipeline FIFO, e.g., a second stage FIFO similar to the buffering present in the PCIe IF User Tx Interface. Each host port may include buffering, e.g., with the transmit FIFOs 426 and limit the bandwidth credit that it advertises to the target device circuitry 108 via the credit release circuitry 429. The credit release circuitry 429 releases credit to the target device based on the requests being sent to root ports 304-312. The credit release circuitry 429 may release the received credits responsive to the FIFO levels in the transmit FIFOs 426. Thus, the local credit release management of the credit release circuitry 429 may be controlled based on the FIFOs 426 readiness to accept traffic rather than rely exclusively on the readiness of the host circuitry 304-312.

The separate FIFOs 426 for the individual ones of the root ports may be used to ensure that a single slow or malfunctioning host device does not impede the operations of other host devices. For example, if a single host device becomes unresponsive the host device's respective FIFO may fill. However, since the other FIFOs are unaffected, credits may continue to be released for others of the connected host devices.

The UCC 214 forwards the request packets it receives from the target device circuitry 108 to the. The UCC 214 forwards the requests in the order UCC 214 receives them from the target device circuitry 108. That is, in one implementation, the UCC 214 does not re-order the request packets the UCC 214 receives from the target device circuitry 108.

The UCC 214, however, need not guarantee any ordering among the different host ports 304-312. Each host port 304-312 also advertises a separate credit to the credit release circuitry 429 in the transmit arbitration circuitry 430. The routing circuitry 414 checks the credit of the appropriate host port before sends the request to the upstream host port.

In order to prevent credit non-availability on one upstream host port from affecting the performance of the other host ports, the transmit arbitration circuitry 430 in the PCIe Bridge (PXP) request queue (PRQ) sub-block of the target device circuitry 108 also checks whether credit is available for the request type on that host port before forwarding the request to the UCC. If credit is not available, the transmit arbitration circuitry 430 moves on to another client (e.g., traffic type TX_Write 442, TX_Read 444, TX_Completion 446) and will service a request for a different host port. The transmit arbitration will service the port that was experiencing congestion only when it returns to service the same original client. For example, the transmit arbitration circuitry 430 may return to servicing the congested host port when it returns to the corresponding client traffic type: TX_Write 442, TX_Read 444, TX_Completion 446.

Since the target device circuitry 108 is not aware that it is connected to multiple host system interfaces in the upstream direction, the UCC 214 may also include resolution circuitry 432. The resolution circuitry 432 resolves sideband signals received on the sideband interface 434, e.g., from each host system and presents a resolved version of the signal to/from the target device circuitry. The sideband signals from the host circuitry may include control signals, such as host power modes, sleep states, or other activity states. The resolution circuitry arbitrates among the control signals from the multiple host systems and resolves a control signal to send over the sideband to the target device circuitry. For example, if one or more of the host devices enter a sleep mode, but at least one remains active, the resolution circuitry may send an active mode indicator over the sideband rather than sending a mix of active and sleep mode signals.

In some cases, the side signals may also include coding control commands. The resolution circuitry may ensure that the protocol control command sent to the target device circuitry resulting in protocol parameters compatible with the active host devices. In some cases, the lowest common denominator transmission parameters may be selected. As active devices switch into inactive states, the transmission parameters may change to allow for changes to the lowest common denominator transmission parameters.

The transmit FIFOs 426 in the UCC 214 also perform as clock domain crossing FIFOs.

In the upstream direction, the UCC 214 performs function mapping. In particular the UCC 214 is configured to receive a device function request on the downstream communication interface 402. The function number translation circuitry 436 maps the device function request to a selected host bus interface among the multiple host bus interfaces, and to a specific function number for the selected host bus interface. Continuing the example above, the function number translation circuitry 436 would map a function request from the target device circuitry 108 for function 1 to host port 0, function 0, while a function request form the target device circuitry 108 for function 3 would be remapped to host port 1, function 1.

Any of the circuitry in FIGS. 3 and 4 may be implemented on a single chip/SoC or distributed across multiple chips. For example, multiple ones of circuitry, 108, 110, and 204-208 may be disposed all on the same or on different chips.

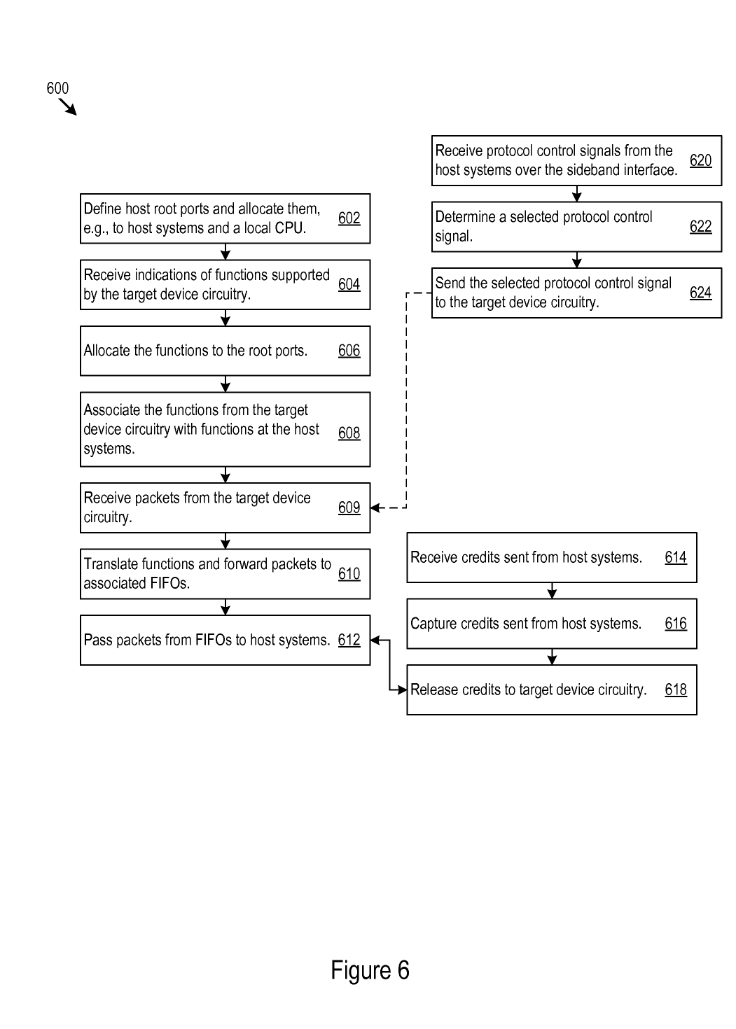

Moving to FIG. 6, logic 600 for upstream communication is shown. The logic 600 may define host root ports and allocate the root ports to host systems 304-312 and a local CPU (602). The logic 600 may receive indications of functions supported by target device circuitry (604). The logic 600 may allocate the functions to the root ports (606). The logic 600 may associate the allocated functions from the target device circuitry 108 with functions at the host systems (608). The association may be implemented by the function number translation circuitry 436. Routing circuitry 414 may receive packets from the target device circuitry (609). The function and function number translation circuitry 436 may determine the target device circuitry function the produced the received packets and forward the packets to the FIFO 426 associated with the host port to which the function has been allocated (610).

The FIFOs 426 pass the packets on to the host systems 304-312 through the communication interfaces 416-424 (612). The host systems 304-312 release credits for TX_Read and TX_Write traffic responsive to the available bandwidth of the host system (614). In some cases, separate credit allocations for TX_Reads and TX_Writes may be released. In some implementations, unlimited or unregulated credits may be advertised for TX_Completions. The credit release circuitry 429 may capture the released credits from the host systems (616). As the FIFOs 426 pass traffic to the host system and empty, the credit release circuitry 429 may release the captured credits to the target device circuitry 108 (618). The credit release circuitry may release credits to the target device circuitry 108 while accounting for the host system bandwidth and the traffic load of the UCC 400.

The logic 600 may receive protocol control signals over sideband interfaces from the root ports (620). The logic 600 may send the protocol control signals to the resolution circuitry 432 for determination of a selected protocol control signal to send over a sideband interface to the target device circuitry 108 (622). The resolution circuitry 432 may then send the selected protocol control signal to the target device circuitry (624).

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

The MHB 110 in which the DCC 212 operates may be tailored to any particular implementation, for instance operating on a 256 bit wide data path at 750 MHz. The root ports 304-312 may operate at different rates as well. The root port assigned to the local CPU may, for instance, operate on a 256 bit data path at 550 MHz, with the remaining root ports operating on a 128 bit data path or 256 bit data path at 550 MHz. The MHB 110 may implement a wide range of other bit widths and operating frequencies. The interface to the target device circuitry 108 may operate, for instance, on a 256 bit or 512 bit wide data path at 550 MHz lower frequency.

Various implementations have been specifically described. However, many other implementations are also possible.

What is claimed is:

1. A system comprising:
an upstream communication interface comprising:
a first host bus interface for a specific bus type, the first host bus interface configured to communicate with a first host system; and
a second host bus interface for the specific bus type, the second host bus interface configured to communicate with a second host system different than the first host system;
a downstream communication interface comprising:
a downstream device bus interface for the specific bus type, the downstream device bus interface configured to provide a downstream connection for the first host bus interface and the second host bus interface to a common instance of target device circuitry; and
communication circuitry between the upstream communication interface and the downstream communication interface, the communication circuitry configured to:
receive a first host request for a specific function number on the first host bus interface;
receive a second host request for the specific function number on the second host bus interface;
obtain a remapped host request by mapping the second host request to a different function number assigned to the second host system for the specific function number;
send the first host request to the target device circuitry; and
send the remapped host request to the target device circuitry.

2. The system of claim 1, where the communication circuitry is further configured to:
determine a range of device function numbers supported by the target device circuitry; and
store a mapping of the device function numbers to the first host bus interface and the second host bus interface.

3. The system of claim 2, where the mapping comprises:
a first sub-range of the device function numbers mapped to: the first host bus interface and a selected function range; and
a second sub-range of the device function numbers mapped to: the second host bus interface and also the selected function range.

4. The system of claim 3, where:
the first sub-range and the second sub-range are non-overlapping.

5. The system of claim 1, where the communication circuitry further comprises:
a first queue for the first host bus interface; and
a second queue for the second host bus interface.

6. The system of claim 5, where the communication circuitry is further configured to:
execute an arbitration between the first queue and the second queue for sending the first host request and the remapped host request to the target device circuitry.

7. The system of claim 6, where:
the arbitration comprises a weighted round-robin arbitration, with weights assigned responsive to bandwidth available to the first host bus interface and the second host bus interface.

8. The system of claim 1, where the communication circuitry is further configured to:
route a received device request received from the target device circuitry on the downstream communication interface to the upstream communication interface.

9. The system of claim 8, where the communication circuitry is further configured to:
obtain a remapped device request by mapping the received device request to: a different function number than originally specified with the device request, and to a specific one of the first host bus interface and second host bus interface.

10. The system of claim 9, where the communication circuitry is further configured to:
determine a range of device function numbers supported by the target device circuitry; and
store a mapping of the device function numbers to the first host bus interface and the second host bus interface.

11. The system of claim 10, where the mapping comprises:
a first sub-range of the device function numbers mapped to: the first host bus interface and a selected function range; and
a second sub-range of the device function numbers mapped to: the second host bus interface and also the selected function range.

12. The system of claim 1, where:
the specific bus type comprises peripheral component interconnect express (PCIe).

13. A method comprising:
determining a range of device function numbers supported by a target device;
storing a mapping of the device function numbers to a first host bus interface and a second host bus interface, where the mapping comprises:
a first sub-range of the device function numbers mapped to: the first host bus interface and a selected function range; and
a second sub-range of the device function numbers mapped to: the second host bus interface and also the selected function range;
advertising the selected function range on the first host bus interface;
advertising the selected function range on the second host bus interface; and
directing host function requests received on the first host bus interface and the second host bus interface to the target device over a device bus interface.

14. The method of claim 13, further comprising:
directing a device function request received on the device bus interface to the first host bus interface or the second host bus interface, but not both.

15. The method of claim 14, further comprising:
determining a specified function number for the device function request; and
mapping the device function request to a mapped function number and to a specific host bus interface among the first and second host bus interfaces.

16. The method of claim 15, where mapping comprises:
mapping to the first host bus interface and retaining the specified function number unchanged as the mapped function number, when the specified function number is within the first sub-range.

17. The method of claim 15, where mapping comprises:
selecting the mapped function number from within the selected function range; and
mapping to the second host bus interface and changing the specified function number to the mapped function number, when the specified function number is within the second sub-range.

18. The method of claim 13, further comprising:
receiving a first host request for a specific function number within the selected function range on the first host bus interface;
receiving a second host request for the specific function number within the selected function range on the second host bus interface; and
obtaining a remapped host request by mapping the second host request to a different function number within the second sub-range; and
sending the first host request to the target device; and
sending the remapped host request to the target device.

19. A system comprising:
an upstream communication interface comprising:
a first host bus interface for a specific bus type, the first host bus interface configured to communicate with a first host system; and
a second host bus interface for the specific bus type, the second host bus interface configured to communicate with a second host system different than the first host system;
a downstream communication interface comprising:
a downstream device bus interface for the specific bus type, the downstream device bus interface configured to provide a downstream connection for the first host bus interface and the second host bus interface to a common instance of target device circuitry;
downstream communication circuitry between the upstream communication interface and the downstream communication interface, the downstream communication circuitry configured to:
receive a first host request for a specific function number on the first host bus interface;
receive a second host request for the specific function number on the second host bus interface;
obtain a remapped host request by mapping the second host request to a different function number assigned to the second host system for the specific function number;
send the first host request to the target device circuitry;
send the remapped host request to the target device circuitry; and
upstream communication circuitry between the upstream communication interface and the downstream communication interface, the upstream circuitry configured to:
receive a device function request on the downstream communication interface; and
map the device function request to a selected host bus interface among the first host bus interface and the second host bus interface, and to the specific function number for the selected host bus interface.

20. The system of claim 19 further comprising:
a mapping of device function numbers supported by the target device circuitry to the first host bus interface and the second host bus interface, where the mapping comprises:
a first sub-range of the device function numbers mapped to: the first host bus interface and a selected function range; and
a second sub-range of the device function numbers mapped to: the second host bus interface and also the selected function range;
the first and second sub-ranges replicating functionality provided by the selected function range.
